(19) United States
(12) Patent Application Publication
(10) Pub. No.: US 2022/0398675 A1
(43) Pub. Date: Dec. 15, 2022

(54) Smart Energy Management System (SEMS)

(71) Applicants: Peter Hartmut Voelkner, Norwalk, CT (US); ReBatt Limited, Wanchai (CN)

(72) Inventor: Peter Hartmut Voelkner, Norwalk, CT (US)

(21) Appl. No.: 17/837,338

(22) Filed: Jun. 10, 2022

Related U.S. Application Data
(60) Provisional application No. 63/210,152, filed on Jun. 14, 2021.

(51) Int. Cl. G06Q 50/06; G05B 15/02

(52) U.S. Cl. CPC G06Q 50/06; G05B 15/02

(57) ABSTRACT

A Smart Energy Management System (SEMS) configured to manage electrical power from diverse power sources and supply electrical power to one or more output buses. Some embodiments feature a generally transportable SEMS where the power sources include power storage devices such as batteries, capacitors, or other devices engineered to store electrical energy and alternatively, power generation or conversion devices such as photovoltaic modules, AC-DC inverters, charging devices, DC dynamos, AC or DC electric generators, and regenerative braking devices.

### CROSS-REFERENCES TO RELATED APPLICATIONS

This application claims priority to U.S. Patent Application Ser. No. 63/210,152 (the “'152 Application”), filed Jun. 14, 2021, by ReBatt Limited (attorney docket no. 1018.07PR), entitled, “Smart Energy Management System (SEMS),” the disclosure of which is incorporated herein by reference in its entirety for all purposes.

### FIELD

The present disclosure relates to systems, apparatus, and methods of managing energy from various sources and supplied to various loads with optimized speed, safety, and efficiency incorporated into a device called the Smart Energy Management System, or SEMS.

### BACKGROUND

Many types of electric devices, conveyances, machines exist which derive power from a power source, battery, capacitor or similar apparatus. In known embodiments, the energy supplied fro the power source may not be efficiently managed and supplied. The embodiments disclosed herein are directed toward overcoming one or more problems noted above.

### SUMMARY

One embodiment disclosed herein is a Smart Energy Management System (SEMS) configured to manage electrical power from a diverse array of power sources and supply electrical power to one or more output buses. The output buses can be connected to a wide variety of motors, electric machinery, or other electric equipment, collectively referred to as the load herein. As detailed below, many embodiments feature a generally transportable SEMS where the power sources include 1) power storage devices such as batteries, capacitors, or other devices engineered to store electrical energy and 2) power generation or conversion devices such as photovoltaic modules, AC-DC inverter charging devices, DC dynamos, AC or DC electric generators, and regenerative braking devices.

In addition to including on-board power storage devices such as batteries and capacitors, the SEMS may be connected to a variety of external power sources of various types to provide alternative sources of power to the output bus or for charging onboard power storage devices as detailed below. Thus, the SEMS is well-suited for managing the input, charging, and output of stored or external electrical power used to operate an electric vehicle, or other mobile off-grid electrical device, a equipment which is not connected to the utility grid, and similar apparatus or equipments.

### BRIEF DESCRIPTION OF THE DRAWINGS

FIG. 1 is a schematic block diagram of a Smart Energy Management System (SEMS), as disclosed herein.

FIG. 2 is schematic circuit diagram of a microcontroller and associated components for a SEMS.

FIG. 3 is schematic circuit diagram of an isolated voltage sensing circuit and associated components for a SEMS.

FIG. 4 is schematic circuit diagram of a voltage step down section and associated components for a SEMS.

FIG. 5 is schematic circuit diagram of an LLC half bridge section and associated components for a SEMS.

FIG. 6 is schematic circuit diagram of a voltage and current surge protection section and associated components for a SEMS.

FIG. 7 is schematic view of a vehicle housing a SEMS.

FIG. 8 is a schematic view of a equipment housing a SEMS.

### DETAILED DESCRIPTION

In the following description, for the purposes of explanation, numerous specific details are set forth to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

The present disclosure relates to systems, apparatus, and methods of managing energy from various sources and supplied to various loads with optimized speed, safety, and efficiency. Energy sources include power stored in electro-chemical storage devices such as batteries, stored in electrical devices such as capacitors, or converted power sources from kinetic energy or gravitational potential energy, converted to electrical power with electricity generation devices such as dynamos and generators, and converted from sunlight such as photovoltaic devices. The disclosed embodiments provide for energy to be supplied as electrical power to electrical loads with optimal speed, safety, and efficiency.

Unless otherwise indicated, “energy” refers to all forms of energy including primarily electrical energy, chemical energy, thermal energy, and kinetic energy. “Power” refers specifically to electrical energy as measured in watts (W), volts (V), and amperes (A). “Stored” electric power refers electric power that is generated from some form of energy and directly or indirectly maintained and controlled within specific parameters through a mechanical, chemical, or electrical device or apparatus. “Direct” electric power refers to electric power that is derived directly from a source of energy with varying intermittency and voltage and current parameters with limited capacity to hold, store, maintain, or control electric power within specific parameters.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

One embodiment disclosed herein is a Smart Energy Management System (SEMS) configured to manage electrical power from a diverse array of power sources and supply electrical power to one or more output buses. The output buses can be connected to a wide variety of motors, electric machinery, or other electric equipment, collectively referred to as the load herein. As detailed below, many embodiments feature a generally transportable SEMS where the power sources include 1) power storage devices such as batteries, capacitors, or other devices engineered to store electrical energy and 2) power generation or conversion devices such as photovoltaic modules, AC-DC inverter charging devices, DC dynamos, AC or DC electric generators, and regenerative braking devices.

In addition to including on-board power storage devices such as batteries and capacitors, the SEMS may be connected to a variety of external power sources of various types to provide alternative sources of power to the output bus or for charging onboard power storage devices as detailed below. Thus, the SEMS is well-suited for managing the input, charging, and output of stored or external electrical power used to operate an electric vehicle, or other mobile off-grid electrical device, a equipment which is not connected to the utility grid, and similar apparatus or equipments.

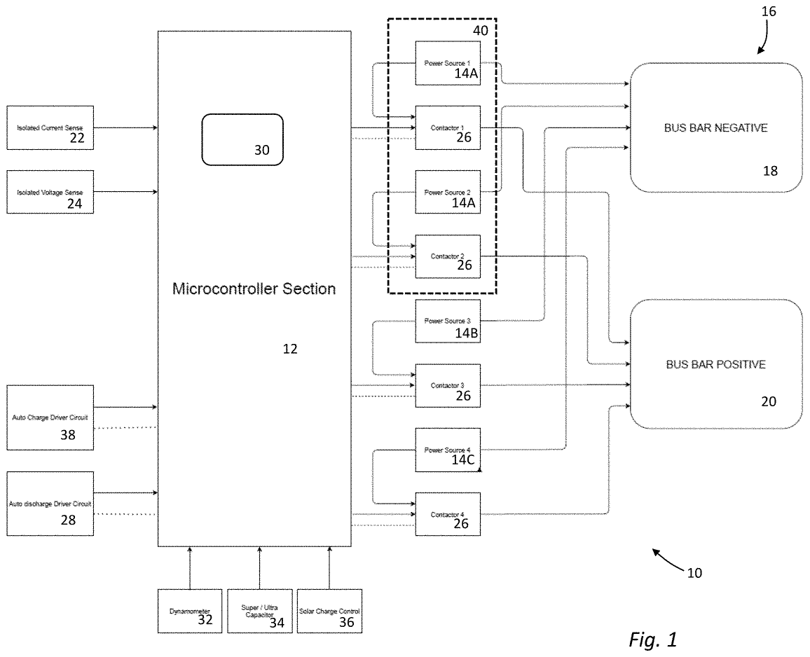

FIG. 1 is a schematic block diagram of a representative SEMS 10. The SEMS 10 features a controller 12 configured to control various operations performed by the SEMS 10 as described herein. The controller 12 may be implemented with a processor, microprocessor, microcontroller, computer, or other circuit configured to implement instructions, routines, or other protocols as required to operate the SEMS 10.

The SEMS 10 further includes multiple power storage devices 14. The block diagram of FIG. 1 shows four separate power storage devices 14, however, the SEMS 10 can be implemented with any suitable number of power sources 14. For example, a SEMS 10 may be implemented with 2, 4, 6, 8, 10, 12 or another number of separate, discrete, and functionally different power storage devices 14. A power storage device 14 may be an on-board power storage device, physically associated with SEMS 10 for example a battery or capacitor.

The SEMS 10 may further includes multiple direct power sources 15. A direct power source 15 may derive power directly or indirectly from other energy sources. These other energy sources can access potential energy to be converted to electrical power to contiuously or intermittently provide electrical power to the SEMS without storing appreciable amounts of electrical power. Representative direct power sources 15 sources include, but are not limited to, photovoltaic solar cells and devices, AC or DC generators, AC or DC regenerative braking controllers, and DC dynamos.

Alternatively, a direct power sources 15 may be a connection to a public utility grid or other stationary source of electrical power.

The power storage devices 14 and the direct power sources 15 of the SEMS 10 are controlled by the controller 12 to provide electrical power to one or more-output buses 16. A typical output bus will include a negative bus bar 18 and a positive bus bar 20. In use, the output bus 16 will be connected to a load that will typically be one or more electrical devices and machinery. For example, the output bus 16 of the SEMS 10 may be connected to a motor driving an electric vehicle, a motor operating machinery, lighting systems, monitoring and control systems including wireless and cellular telemetry systems, transmitting and communications equipment, or any device or apparatus requiring electrical power.

The electrical connections between the various power storage devices 14, direct power sources 15 and the output bus 16 are sized to carry an appropriate voltage and current respective to the associated loads. For example, in a SEMS 10 configured to power an electric vehicle, the wiring, traces, or other electrical connections between the various power storage devices 14, direct power sources 15 and the output bus 16 may be sized to convey voltage in the range of between 42V and 80V having a maximum current of 350 A. Other SEMS 10 may be configured to have other output voltage and current capacities that are suitable for the intended loads.

Representative power storage devices 14 can be batteries 14A, capacitors 14B, or alternative power storage devices having suitable electrical characteristics within predetermined parameters associated with the device specifications. Different types, makes, or models of devices can have different and various specifications. If some or all the power storage devices 14 are batteries 14A, the SEMS 10 can be configured to provide a suitable output voltage and current to the output bus 16 using power input from a wide range of battery types, battery chemistries, battery architectures or batteries having different voltage, peak discharge, and other characteristics within predetermined parameters.

For example, the SEMS 10 is configured to condition power to have a suitable output voltage and current when supplied from either a lithium-ion battery or a lead-acid battery. More specifically, the batteries 14A could be a dissimilar set where individual batteries are any type of a lithium-chemistry based battery, for example, a lithium cobalt oxide battery, a lithium manganese oxide battery, a lithium nickel manganese cobalt oxide battery, a lithium iron phosphate battery, a lithium nickel cobalt aluminum oxide battery, a lithium titanate battery, a solid-state lithium-ion battery, a lithium sulfur battery, a lithium air battery, a nickel metal hydride (NMh) based battery, nickel-cadimium (NiCad) based battery, any type of lead acid or AGM battery, or any future battery technology including electrolytic and solid state batteries, and any other power storage device having appropriate electrical characteristics to connect to the SEMS in terms of suitable voltage and current parameters.

Thus, a first battery 14A in communication with the SEMS 10 may have a voltage of between, for example, 10V and 110V. A second or subsequent batteries may have different voltages, discharge rates and other differences in power output within pre-determined parameters. A representative SEMS 10 may accept input power from any combination of 12V, 24V, 48V, 60V and 72V batteries, or batteries having another suitable voltage. Even though the batteries 14A, capacitors 14B or other power storage devices 14 have different physical, chemical and electrical characteristics, the SEMS 10 is configured to accept power from the power storage devices according to the optimal parameters in order to maximize speed, efficiency, safety, and longevity of the power storage devices.

Similarly, when recharging the power storage devices 14 the SEMS sends electrical power to the power storage devices 14 for optimal recharging speed, efficiency, safety, and longevity of the power storage devices 14.

This level of flexibility is achieved by the controller 12 and ancillary components. For example, as shown on FIG. 1, the controller 12 can receive isolated current detection and quantification information through a current sense module 22 communicating with any power storage device 14. Similarly, the controller 12 can receive isolated voltage detection and quantification information from any power storage device 14 through a voltage sense module 24 communicating with any power storage device 14. Additional circuitry associated with the SEMS 10 can condition the output power to a desired voltage and current level based upon the detected input voltage and current levels. Other circuitry can rectify the input from an AC power source to supply DC current to the output, or invert input from a DC power source to supply AC current to the output, as required by the load.

In embodiments where the power storage device 14 is a capacitor 14B, the capacitor can be of any configuration including, but not limited to, supercapacitors and ultracapacitors configured to rapidly store and deliver large quantities of electrical energy, or to accept intermittent power of various voltages and currents from various power sources and release this power to storage devices or loads according to specified ranges of voltage and current.

As noted above, the SEMS 10 may also include or be connected to one multiple direct power sources 15 which may or may not intermittently supply power under various parameters. Intermittent direct power sources 15 include but are not limited to solar cells, AC or DC generators, AC or DC regenerative braking controllers, DC dynamos and the like. Intermittent direct power sources 15 provide electrical power at a wide range of current and voltage that may or may not be compatible with the predefined recharging parameters of any attached power storage devices 14, such as a battery 14A, or an electrical load, such as an electric motor or lighting system. When the power parameters, in terms of the current and voltage, of the intermittent direct power source 15 is not directly compatible with the attached power storage device(s) or load(s), all or a portion of the power provided from a direct power source 15 can be lost as heat or other electrical impedance loses causing a loss of electrical system efficiency. Therefore, the SEMS 10 is configured to accept and modify or condition power from the direct power sources 15 according to opimized parameters to enhance and optimize the speed, efficiency, safety, and longevity of the entire electrical system. This functions as a Maximum Power Point Tracking (MPPT) feature for accepting and storing power.

Alternatively, the SEMS 10 may accept certain power in watts within certain ranges of voltage and current and efficiently deliver the power in watts to a load according to optimized voltage and current required by the device producing the load or the device storing the power. This functions as a Maximum Power Point Tracking (MPPT) feature for delivering optimally configured power to loads and storage devices in order to achieve maximum speed, safety, and efficiency.

Alternatively, a direct power source 15 may be a connection to a public utility grid or other less portable but constant external source of electrical energy. In these instances, the SEMS 10 can accept input power over a wide range of input voltages and currents to create and provide a proper output voltage and current to the output bus 16. Furthermore, as described in detail below, power from a wide variety direct power sources may be used to provide charging current for onboard batteries 14A or storage capacitors 14B included with the SEMS 10.

In addition to controlling the output voltage and current, the SEMS 10 may include circuitry to optimize the electrical interfaces between all electrical devices connected to it, including the management of current and voltage surges, imbalances, and drops for smooth acceptance of charging current from direct power sources 15 to the power storage devices 14 and discharge to the output bus 16 as needed by the load. Selected embodiments use capacitors, supercapacitors, and ultracapacitors to manage charging and discharging from the multiple inputs and outputs with high efficiency.

The SEMS is designed to optimize efficiency by maximizing the speed and flexibility of the various and simultaneous connections with power storage devices 14, direct power sources 15, and electrical loads. Rapid and efficient energy management is necessary because of the rapidly changing operational conditions the SEMS 10 may face. For example, a power storage device 14 may be required to intermittently discharge and recharge at potentially sub-one-second intervals. In addition, any direct power sources may deliver a broad range of voltages and currents at potentially sub-one-second intervals. Also, the electrical loads can vary across a broad range within a short time period and can intermittently switch from being a load to being a direct power source 15, such as the case of an electric motor (load) with regenerative braking capabilities (direct power source). Furthermore, each of these various and different electrical devices have optimal parameters for the delivery and acceptance of electrical power in terms of optimal ranges for current, voltage and minimum or maximum duration for charging or discharging of electrical power.

Operation of the SEMS 10 from a wide variety of different power sources 14 and 15 provides a user with a great deal of flexibility. The use of multiple power storage devices 14 (batteries, capacitors, or other) with different specifications allows a user to service the output load with an optimized configuration of power storage devices 14 based on power density, cost, availability, safety weight, size, ruggedness, and other considerations.

In many embodiments, the controller 12 and associated components permit both manual and/or automated discharging of selected power storage devices 14. As shown on FIG. 1, each power storage device 14 is connected to the output bus 16 through a contactor 26, high-power relay or similar device. The contacts of the contactor 26 are controlled by a signal from the microcontroller 12 such that the user may manually select one of the power storage devices 14 to connect to the output bus 16. Alternatively, logic or a protocol associated with the microcontroller, in conjunction with an auto discharge driver circuit 28, may automatically select one or more power storage devices 14 for connection to the output bus 16 based upon the requirements of the load.

Manual control and systemwide monitoring may be implemented by placing the controller in communication with a control panel 30 that includes some combination of switches, indicators, voltage gauges, amp meters, and other status indicators. The control panel may also include one or more displays, interfaces, input devices, control apparatus, and the like as needed to control, monitor, or communicate the status of any system component, to monitor automatic control, or perform manual control over various aspects of the SEMS 10.

As noted above, the SEMS 10 supports the periodic charging of onboard power storage devices 14A and 14B from various charging sources. The SEMS 10 is configured to accept and properly condition a charging current received from charging sources having different physical, electrical, or other characteristics, within a wide range of acceptable parameters.

For example, the SEMS 10 may receive charging current input from a dynamo, AC or DC generator, or power associated with a regenerative braking apparatus working with the electric motor, from devices equipped with a supercapacitor or ultracapacitor, or from a module with photovoltaic solar cells. It is important to note that the microcontroller 12 is configured to process or transform the charging current into an appropriate charging current for a selected power storage device. For example, a charging input may be converted between AC and DC power, be voltage regulated, and be current regulated by amplitude and frequency as required to match the optimum charging specifications of the onboard power storage device 14A or 14B. In addition, the controller 12 includes smart-charging logic which applies charging current to the onboard power storage device 14A or 14B according to a charging scheme of any complexity which is suitable to the device being charged. The components and smart-charging logic minimize power loss due to inefficiency in electrical connections and components and maximize the power available for recharging and supplying to loads. The efficiency of the electrical system is further enhanced by faster speed and greater flexibility in detecting, controlling, balancing, and processing variable power supplies and loads from the various devices connected to the SEMS.

Charging operations may be controlled manually, typically utilizing appropriate switches or functions on the control panel 30. Alternatively, charging operations may be controlled automatically, using for example an auto charge driver circuit 38 in communication with the microcontroller 12 and electrically positioned between the external power source and the device being charged.

As noted above certain energy sources, for example, a dynamo, AC or DC generator, or charging current associated with a regenerative braking apparatus, a device equipped with a supercapacitor or ultracapacitor, a module of photovoltaic solar cells, or other energy sources may perform the dual function of providing a charging current to charge onboard power storage devices 14A and 14B, or optionally providing power to the output bus 16. Switching between these functions can be performed manually or automatically if a suitable external power source is connected to the SEMS 10.

In some embodiments, the SEMS 10 may include a battery box 40 configured to house batteries having various configurations that are being used as power storage devices 14A. The battery box 40 may include adjustable partitions and adjustable cables or connectors of various types suitable for connecting one or more batteries to the system. The battery box may house an optional active cooling fan. In some embodiments, an auxiliary power storage device, such as a battery or device equipped with supercapacitors or ultracapacitors, can be located outside of the battery box, such as under a vehicle driver seat.

A battery box 14 may be provided with a variety of connectors that are compatible with commercially available power storage devices provided by third-parties under long- or short-term usage agreements, commonly known as “battery-swapping” vendors. The SEMS 10 can utilize these third-party battery swapping devices as an auxiliary power storage device to service the power needs of the SEMS 10 without limitation to any one type of swappable power storage device. Based on the availability, proximity, commercial terms such as cost and payment method, storage capacity, reliability, and other considerations, the vehicle equipped with the SEMS can have greater flexibility in operating range and performance and lower total cost of ownership by being able to utilize the infrastructure of third-party battery swapping vendors in addition to the onboard power storage devices.

The Smart SEMS 10 may include various ancillary circuits or logic providing safety, convenience, and efficiency. Ancillary circuits or logic include but are not necessarily limited to providing at least some of the following: overcharge prevention, over-discharge prevention, charging temperature compensation, input surge protection, output current, voltage, and surge protection, output short circuit protection, and managing output current or voltage imbalances.

In addition, the SEMS 10 may, in certain embodiments, facilitate the high-speed and/or high-efficiency acceptance of charging power from any source using ultracapacitors or supercapacitors. These components provide for less than one second to less than several seconds, for example less than 20 seconds, current acceptance to the SEMS 10 to maximize charging power efficiency, minimize charging power losses, and to optimize power service to the load through the output bus 16 when a suitable input is used as an external power source.

High-speed and high-efficiency output of power to the load through the output bus 16 is also enhanced using ultracapacitors or supercapacitors in the output. Suitable capacitor banks facilitate the delivery of power in optimal ranges for the load being serviced which can include one or more electric motors, electronic devices, lighting, signaling, and other electrical loads.

In certain embodiments, the controller may optionally be in communication with other subsystems. For example, a vehicle-based SEMS 10 may communicate with other vehicle subsystems using a controller area network or bus (CAN). A CAN communications bus is a robust vehicle bus standard designed to allow microcontrollers and devices to communicate with each other's applications without a host computer.

In certain embodiments, the SEMS 10 will communicate with the electric motor controller to optimize power delivery and recharging from regenerative braking. The speed of the components used to connect the SEMS 10 to the motor controller significantly influences the overall efficiency of the electrical system. The use of capacitors, supercapacitors, and ultracapacitors can improve the speed of power management and the overall efficiency of the electrical system.

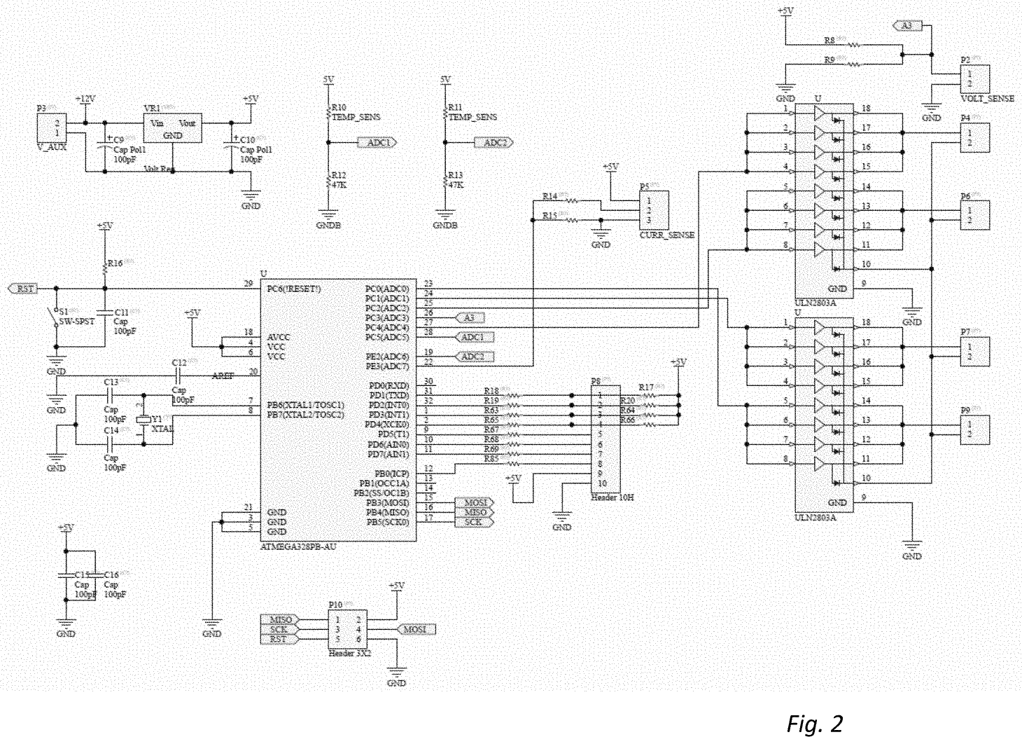

Specific, and non-limiting examples of several of the features, circuits and components described generally above with respect to FIG. 1 are shown in the schematic diagrams of FIGS. 2-6. It is important to note that the specific circuits shown in FIGS. 2-6 are not intended to limit the scope of this disclosure. On the contrary, the specific circuits of FIGS. 2-6 are representative examples of circuits suitable for accomplishing the functionality described above.

For example, FIG. 2 is a representative circuit diagram showing a microcontroller 12 and associated components for a SEMS 10. This circuit, module, or component is used to monitor the battery voltage, protect the battery, provide estimates of the battery state or condition, maximize the battery's performance, and includes diagnostic features and reporting functionality configured to report to the user various faults and other status signals.

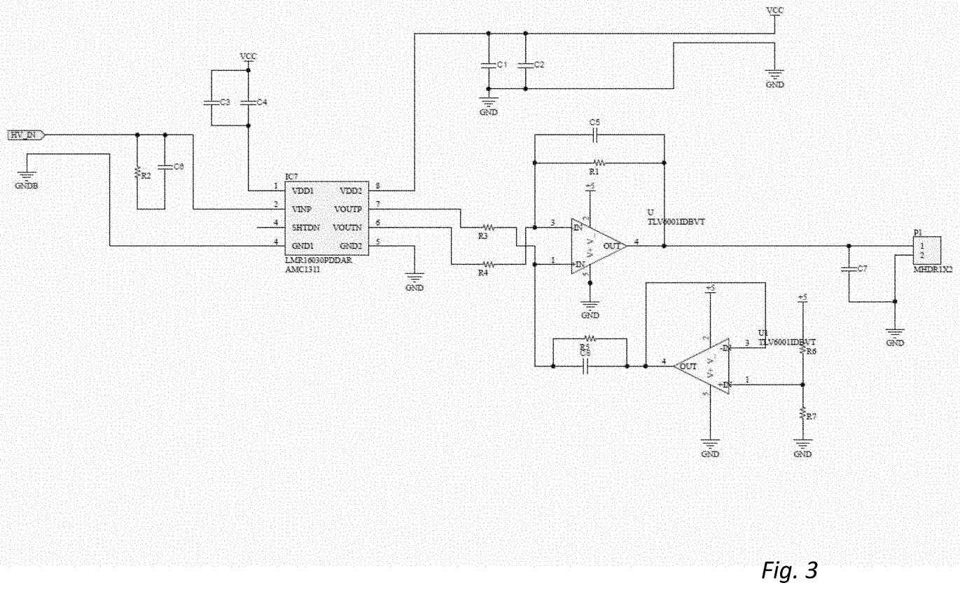

FIG. 3 is representative schematic circuit diagram of an input voltage sensing circuit and associated components for a SEMS 10. This section is used to monitor the input bus voltage using an isolated amplifier circuit along with an operational amplifier acting as a unity gain amplifier. The unity gain amplifier is usually used to match the impedance of the load with the source so that maximum current is transferred from the source to the load. In addition, isolated sensing may be used to separate the high power ground with the control circuit ground.

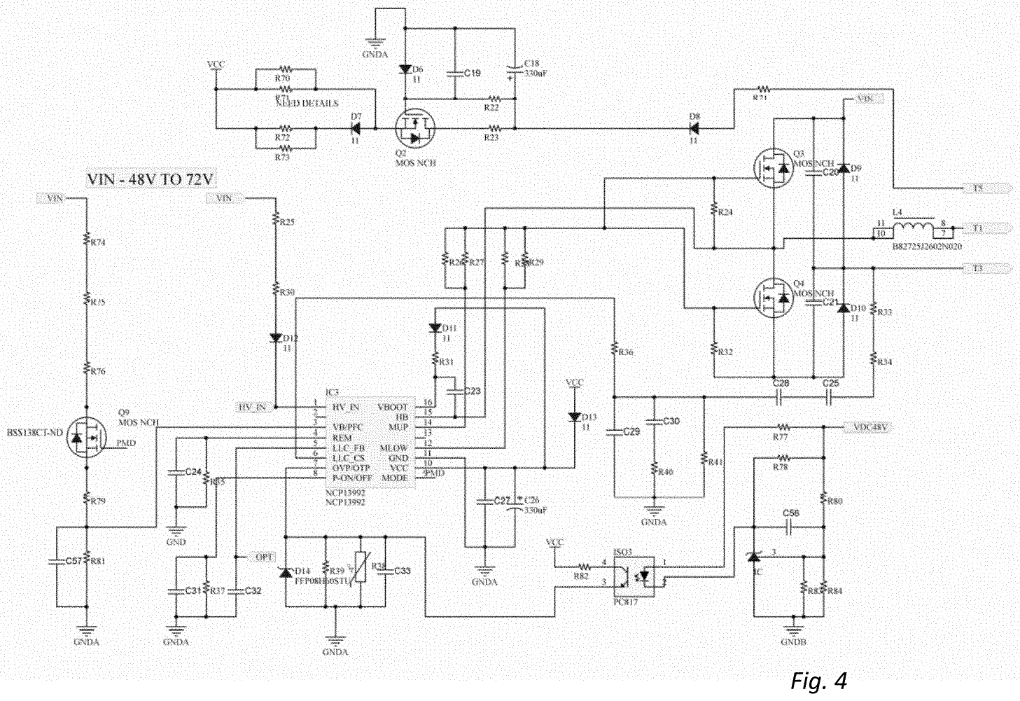

FIG. 4 is representative schematic circuit diagram of an input voltage step down, step up, or modification circuit and associated components for a SEMS 10. The circuit illustrated in FIG. 4 or a similar circuit functions to match the voltage or current of various sources to the output voltage and current required at the output bus 18, 20. User input or programming received, for example, from the CAN interface, the voltage from the source is stepped up or stepped down to match the load specifications. This circuit may also be used to smooth out the voltage and/or current curves to match the load specifications. This circuit can also perform additional functions such as improvement of the power factor, reducing the current and voltage ripple at the output, or other functions.

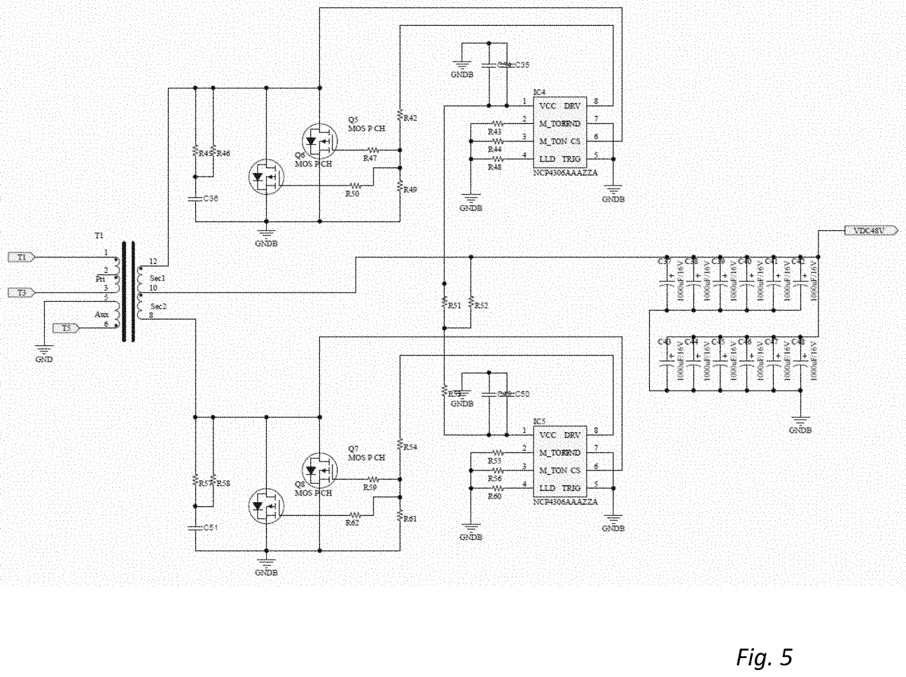

FIG. 5 is representative schematic circuit diagram of an LLC half bridge circuit and associated components for a SEMS 10. The LLC half-bridge or a similar circuit is used for AC/DC conversion processes including but not limited to inverter functionality. The illustrated and similar LLC tank circuits effectively filter out harmonics providing a sinusoidal like voltage and current waveform. The converter power flow is controlled by modulating the square wave frequency with respect to the tank circuit's resonance. The illustrated circuit has high efficiency, low EMI and high power density.

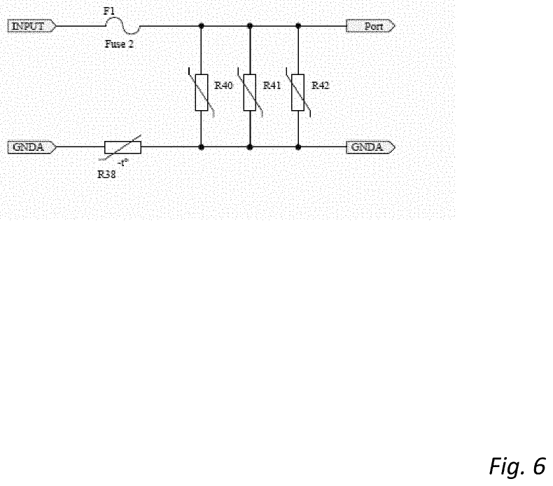

FIG. 6 is a representative schematic circuit diagram of a voltage and current surge protection circuit and associated components, providing output voltage and current protection for a SEMS 10. The illustrated embodiment consists of Metal Oxide Varistors (MOV's) and Transient Voltage suppressor diodes (TVS) connected in between the positive and negative terminal of battery. Also, the illustrated circuit consists of Mosfets connected in series between source and load which are driven by an integrated circuit which is used to turn off the Mosfet in case of battery reversal. Metal Oxide Varistors (MOV's) are the most commonly used components that are used as voltage clamping devices to protect small or heavy devices from transient voltage surges. Since a metal oxide is used in its construction, the ability to absorb short voltage transients and the energy handling capabilities are extremely high. Transient voltage suppressors or TVS are protection devices that are used to save circuits from a sudden spike in voltage or current. The primary function of these TVS diodes is to protect a circuit from overvoltage. The reverse battery polarity protection circuit prevents damage to the internal electronics in the event of reverse battery installation, accidental short circuiting, or other inappropriate operation.

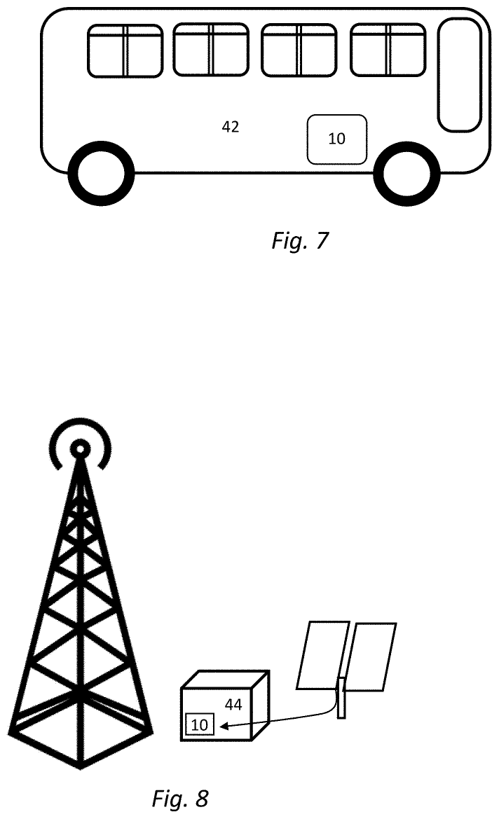

Alternative embodiments within the scope of this disclosure include a vehicle supporting or housing a SEMS 10 as described above. In a vehicle embodiment, the vehicle may be of any sort, including but not limited to a car, truck, bus, motorcycle, locomotive train, three wheel vehicle, Tuk-Tuk, auto rickshaw, or other wheeled or tracked vehicle. For example, as shown in FIG. 7, the vehicle could be a bus 42 housing a SEMS 10 which is connected to one or more electric drive motors and which receives charging current from a regenerative braking apparatus. In alternative embodiments the vehicle could be an airplane, boat, or other type of vehicle.

Another alternative embodiment within the scope of this disclosure is a equipment housing a SEMS 10. The equipment may be any sort of mobile or fixed equipment or building associated with electrically powered apparatus. For example, one representative equipment embodiment is the broadcasting shed 44 housing a SEMS 10 as shown on FIG. 8. The SEMS 10 is particularly well suited to off-grid equipments, although a SEMS can be housed in a grid-tied equipment as well. Other equipment suitable for housing a SEMS 10 include houses, office buildings, hospitals, warehouses, schools, and the like.

Having described certain exemplary embodiments, it will be understood by those skilled in the art that many changes in construction and widely differing embodiments and applications of the invention will suggest themselves without departing from the scope of the present invention.

Hence, while various embodiments are described with, or without, certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A smart energy management system (SEMS) comprising:
a controller;
a first power input in electrical communication with the controller which may be AC or DC;
a second power input device in electrical communication with the controller which may be AC or DC wherein the second power input device has different electrical and physical characteristics than the first power input device; and
first power storage device in electrical communication with the controller;
a second power storage device in electrical communication with the controller; wherein the second power storage device has different electrical and physical characteristics than the first power storage device; and
an output bus in electrical communication with the first power storage device and the second power storage device, wherein the controller is configured to;
select the first power storage device and receive a first input power from the first power storage device;
select the second power storage device and receive a second input power from the second power storage device;
convert the first input power or the second input power to an output power having a set of output power characteristics based upon the requirements of a load, wherein the set of output characteristics are the same whether the controller is converting the first input power or the second input power; and
supply the output power to the output bus.

2. The SEMS of claim 1 wherein:
the first power input device comprises an AC-DC converter for charging of batteries; and
the second power input device comprises an DC-DC power source such as a DC generator, photovoltaic module, or similar source of power; and
the first power storage device comprises a battery of a certain chemistry and design; and
the second power storage device comprises a capacitor, a second battery of a different chemistry or design, or some other short-term energy storage device which is capable of rapid charging and discharging over many cycles.

3. The SEMS of claim 1 wherein:
the first power storage device comprises a lithium-ion battery; and
the second power storage device comprises a lead-acid battery.

4. The SEMS of claim 1 wherein:
the first power storage device comprises a first battery having a first voltage; and
the second power storage device comprises a second battery having a second voltage.

5. The SEMS of claim 1 wherein:
the first power storage device comprises a first battery having a first internal chemistry; and
the second power storage device comprises a second battery having a second internal chemistry.

6. The SEMS of claim 1 wherein:
the first power storage device comprises a first battery having a first internal architecture; and
the second power storage device comprises a second battery having a second internal architecture.

7. The SEMS of claim 1 wherein:
the first power storage device comprises one of a lithium cobalt oxide battery, a lithium manganese oxide battery, a lithium nickel manganese cobalt oxide battery, a lithium iron phosphate battery, a lithium nickel cobalt aluminum oxide battery, a lithium titanate battery, a solid-state lithium-ion battery, a lithium sulfur battery, a lithium air battery, a nickel-based battery, a lead-acid battery, or an AGM battery; and
the second power storage device comprises a different one of a lithium cobalt oxide battery, a lithium manganese oxide battery, a lithium nickel manganese cobalt oxide battery, a lithium iron phosphate battery, a lithium nickel cobalt aluminum oxide battery, a lithium titanate battery, a solid-state lithium-ion battery, a lithium sulfur battery, a lithium air battery, a nickel-based battery, a lead-acid battery, or an AGM battery.

8. The SEMS of claim 1 wherein the first input power has a first voltage of between 10V and 110V and the second input power has a second voltage of between 10V and 110V that is different than the first voltage.

9. The SEMS of claim 1 wherein the output power has an output voltage of between 42V and 80V.

10. The SEMS of claim 1 wherein the output power has an output current of equal to or less than 350 A.

11. The SEMS of claim 1 further comprising one or more ultracapacitors or supercapacitors in electrical communication with the output bus.

12. The SEMS of claim 1 further comprising a manual or automatic switch in communication with the controller, wherein the manual or automatic switch is configured to select which of the first power storage device and the second power storage device provides power to the output bus.

13. The SEMS of claim 1 further comprising:
a first external power port in electrical communication with the controller;
wherein the controller is configured to:
select the first external power port to receive a third input power from a first external power source; and
convert the third input power to the output power having the set of output power characteristics that is the same whether the controller is converting the first input power, the second input power, or the third input power.

14. The SEMS of claim 13, wherein the first external power source comprises one of a solar module, an electric generator, or a regenerative braking apparatus.

15. The SEMS of claim 1 further comprising:
a first charging input in electrical communication with the controller; and
a second charging input in electrical configuration with the controller,
wherein:
the controller is configured to accept electricity through the first charging input from a first charging source; and
the controller is configured to accept electricity through the second charging input from a second charging source, wherein the second charging source has different physical and electrical characteristics than the first charging source.

16. The SEMS of claim 15 further comprising one or more ultracapacitors or supercapacitors, or other short-term energy storage device, in electrical communication with the first charging input and the second charging input.

17. The SEMS of claim 15 wherein:
the first charging source is one of a solar module, an electric generator, a regenerative braking apparatus, an AC power source, a connection to a regional electrical grid, an inverter, a battery, or a capacitor; and
the second charging source is a different one of a solar module, an electric generator, a regenerative braking apparatus, an AC power source, a connection to a regional electrical grid, an inverter, a battery, or a capacitor.

18. Equipment, mobile or stationary, comprising a smart energy management system (SEMS), wherein the SEMS comprises:
a controller;
a first power storage device in electrical communication with the controller;
a second power storage device in electrical communication with the controller; wherein the second power storage device has different electrical and physical characteristics than the first power storage device; and
an output bus in electrical communication with the first power storage device and the second power storage device, wherein the controller is configured to;
select the first power storage device and receive a first input power from the first power storage device;
select the second power storage device and receive a second input power from the second power storage device;
convert the first input power or the second input power to an output power having a set of output power characteristics based upon the requirements of a load, wherein the set of output characteristics are the same whether the controller is converting the first input power or the second input power; and
supply the output power to the output bus.

19. The equipment of claim 18 wherein:
the first power storage device comprises a battery; and
the second power storage device comprises a capacitor.

20. The equipment of claim 18 wherein:
the first power storage device comprises a lithium-ion battery; and
the second power storage device comprises a lead-acid battery.

21. The equipment of claim 18 wherein:
the first power storage device comprises a first battery having a first voltage; and
the second power storage device comprises a second battery having a second voltage.

22. The equipment of claim 18 wherein:
the first power storage device comprises a first battery having a first internal chemistry; and
the second power storage device comprises a second battery having a second internal chemistry.

23. The equipment of claim 18 wherein:
the first power storage device comprises a first battery having a first internal architecture; and
the second power storage device comprises a second battery having a second internal architecture.

24. The equipment of claim 18 wherein:
the first power storage device comprises one of a lithium cobalt oxide battery, a lithium manganese oxide battery, a lithium nickel manganese cobalt oxide battery, a lithium iron phosphate battery, a lithium nickel cobalt aluminum oxide battery, a lithium titanate battery, a solid-state lithium-ion battery, a lithium sulfur battery, a lithium air battery, a nickel-based battery, a lead-acid battery, or an AGM battery; and
the second power storage device comprises a different one of a lithium cobalt oxide battery, a lithium manganese oxide battery, a lithium nickel manganese cobalt oxide battery, a lithium iron phosphate battery, a lithium nickel cobalt aluminum oxide battery, a lithium titanate battery, a solid-state lithium-ion battery, a lithium sulfur battery, a lithium air battery, a nickel-based battery, a lead-acid battery, or an AGM battery.

25. The equipment of claim 18 wherein the first input power has a first voltage of between 10V and 110V and the second input power has a second voltage of between 10V and 110V that is different than the first voltage.

26. The equipment of claim 18 wherein the output power has an output voltage of between 42V and 80V.

27. The equipment of claim 18 wherein the output power has an output current of equal to or less than 350 A.

28. The equipment of claim 18 further comprising one or more ultracapacitors or supercapacitors in electrical communication with the output bus.

29. The equipment of claim 18 further comprising a manual or automatic switch in communication with the controller, wherein the manual or automatic switch is configured to select which of the first power storage device and the second power storage device provides power to the output bus.

30. The equipment of claim 18 further comprising a display in communication with the controller, wherein the display displays at least a voltage of the first power storage device and a voltage of the second power storage device.

31. The equipment of claim 18 further comprising:
a first external power port in electrical communication with the controller;
wherein the controller is configured to:
select the first external power port to receive a third input power from a first external power source; and
convert the third input power to the output power having the set of output power characteristics that is the same whether the controller is converting the first input power, the second input power, or the third input power.

32. The equipment of claim 31, wherein the first external power source comprises one of a solar module, an electric generator, or a regenerative braking apparatus.

33. The equipment of claim 18 further comprising:
a first charging input in electrical communication with the controller; and
a second charging input in electrical configuration with the controller,
wherein:
the controller is configured to accept electricity through the first charging input from a first charging source; and
the controller is configured to accept electricity through the second charging input from a second charging source, wherein the second charging source has different physical and electrical characteristics than the first charging source.

34. The equipment of claim 33 further comprising one or more ultracapacitors or supercapacitors in electrical communication with the first charging input and the second charging input.

35. The equipment of claim 33 wherein:
the first charging source is one of a solar module, an electric generator, a regenerative braking apparatus, an AC power source, a connection to a regional electrical grid, an inverter, a battery, or a capacitor; and
the second charging source is a different one of a solar module, an electric generator, a regenerative braking apparatus, an AC power source, a connection to a regional electrical grid, an inverter, a battery, or a capacitor.
